(19) United States
(12) Patent Application Publication
(10) Pub. No.: US 2023/0152147 A1
(43) Pub. Date: May 18, 2023

(54) AUTOMATED WEIGHT SCALE NUTRIENT AND CALORIC MONITORING SYSTEM

(71) Applicant: VersaWare Technologies, Inc., Southfield, MI (US)

(72) Inventors: Creed McKinnon, San Diego, CA (US); Jacob Lindberg, San Diego, CA (US)

(21) Appl. No.: 17/990,351

(22) Filed: Nov. 18, 2022

Related U.S. Application Data
(60) Provisional application No. 63/339,273, filed on May 6, 2022.
(60) Provisional application No. 63/280,768, filed on Nov. 18, 2021.

(51) Int. Cl. G01G 19/414; G01G 21/28; G01G 23/14; G01G 23/37

(52) U.S. Cl. CPC G01G 19/4146; G01G 21/283; G01G 23/14; G01G 23/3728

(57) ABSTRACT

A smart base for use with an automated weight scale nutrient and caloric monitoring system is provided. The smart base includes an enclosure and one or more load cells positioned proximate the enclosure and configured to weigh consumable items. A microprocessor is positioned proximate the enclosure and has a processor, an analog-to-digital converter and an input/output interface. A wireless interface, a display interface and a power source are positioned proximate the enclosure. The power source is configured to power the one or more load cells, the microprocessor, the wireless interface and the display interface. The one or more load sensors are configured to measure weight data of consumable items. The microprocessor and the wireless interface are configured to generate an output signal indicative of the measured weight data and transmit the output signal to an electronic device in real-time while the consumable item is being weighed.

### CROSS REFERENCE TO RELATED APPLICATIONS

This application claims the benefit of U.S. Provisional Application No. 63/280,768, filed on Nov. 18, 2021, and U.S. Provisional Application No. 63/339,273, filed on May 6, 2022, the entire disclosures of which are hereby incorporated herein by reference.

### FIELD

The present disclosure relates to health tracking systems, and more particularly, to a measuring system configured for communication with a computer processor and, in some embodiments, a data network and cloud-smart based computer software.

### INTRODUCTION

This section provides background information related to the present disclosure which is not necessarily prior art.

Millions of health-conscious individuals utilize some means to track macronutrients and calorie data of the food they consume each day to achieve health and fitness goals. Currently, there are over 67 million people who utilize health and wellness applications downloaded directly to a smart phone or similar device to help stay accountable to health goals. Typically, the user weighs every ingredient of their meal using a food scale and manually enters the weight data into the mobile application.

Existing industry applications, such as the non-limiting example of MyFitnessPal®, can be extremely complicated and burdensome due to the spreadsheet accounting that is needed to use the application. Transferring food back and forth between kitchen appliances, cutting boards, and food scales, among other devices, to obtain the weight data is time consuming, inefficient, and labor intensive due to having to weigh each ingredient separately and manually log the weight data for each individual ingredient within these applications.

There is a continuing need for systems and methods that simplify the process of obtaining and tracking nutrients, macronutrients and calorie data to save time and effort, where such systems and methods utilize kitchen appliances linked to a mobile application.

### SUMMARY

In concordance with the instant disclosure, systems and methods that simplify the process of obtaining and tracking nutrients, macronutrients and calorie data to save time and effort, where such systems and methods utilize kitchen appliances linked to a mobile application, are surprisingly discovered.

It should be appreciated that this summary is provided to introduce a selection of concepts in a simplified form, the concepts being further described below. This summary is not intended to identify key features or essential features of this disclosure, nor is it intended to limit the scope of the weight scale with computer processor and internet connectability for automated macronutrient and caloric monitoring and tracking.

The above objects as well as other objects not specifically enumerated are achieved by a smart base for use with an automated weight scale nutrient and caloric monitoring system. The smart base includes an enclosure and one or more load cells positioned proximate the enclosure and configured to weigh consumable items. A microprocessor is positioned proximate the enclosure and has a processor, an analog-to-digital converter and an input/output interface. A wireless interface is positioned proximate the enclosure. A display interface is positioned approximate the enclosure. A power source is positioned approximate the enclosure and is configured to power the one or more load cells, the microprocessor, the wireless interface and the display interface. The one or more load sensors are configured to measure weight data of consumable items. The microprocessor is configured to generate an output signal indicative of the measured weight data. The wireless interface is configured to transmit the measured weight data to an electronic device in real-time while the consumable item is being weighed by the one or more load cells.

The above objects as well as other objects not specifically enumerated are also achieved by an automated weight scale nutrient and caloric monitoring system. The automated weight scale nutrient and caloric monitoring system includes a smart base having electronic components and one or more load sensors. A vessel is configured to seat on the smart base and is further configured to receive consumable items. An electronic device is in communication with the smart base. The one or more load sensors are configured to measure weight data of the consumable items placed in the vessel and the electronic components are configured to generate an output signal indicative of the measured weight data. The electronic components are further configured to transmit the measured weight data to an electronic device in real-time while the consumable item is being weighed by the smart base.

The above objects as well as other objects not specifically enumerated are also achieved by a method of operating an automated weight scale nutrient and caloric monitoring system. The method includes the steps of selecting a recipe and/or ingredient from a selection of saved recipes and/or ingredients, adding a first ingredient to a vessel cavity; weighing the weight of the first ingredient using one or more load sensors; generating and sending analog signals representing the weight of the first ingredient to an analog-to-digital converter; converting the analog-to-digital signals to digital signals; communicating the digital signals in real time to an electronic device; displaying the communicated digital signals on a health tracking application accessed by the electronic device; adding a second ingredient to the vessel cavity without removing the first ingredient; weighing the weight of the second ingredient using one or more load sensors; and displaying an aggregate meal page listing all the ingredients, along with the macronutrients and calorie data for each ingredient.

Further areas of applicability will become apparent from the description provided herein. It should be understood that the description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1A is a right side perspective view of an automated weight scale nutrient and caloric monitoring system in accordance with one embodiment of the invention.

FIG. 1B is an exploded perspective view of the automated weight scale nutrient and caloric monitoring system of FIG. 1A.

FIG. 2 is a schematic diagram of electrical components of the automated weight scale nutrient and caloric monitoring system of FIG. 1A.

FIG. 3 is a schematic diagram of electrical components of the automated weight scale nutrient and caloric monitoring system of FIG. 1A.

FIG. 4 is a schematic depiction of the automated weight scale nutrient and caloric monitoring system of FIG. 1A in communication with an electronic device.

FIG. 5 is a schematic depiction of a display of the electronic device of FIG. 4.

FIG. 6 is a block diagram of various graphical user interfaces of the automated weight scale nutrient and caloric monitoring system of FIG. 1A.

FIG. 7 is a block diagram illustrating a method of operating the automated weight scale nutrient and caloric monitoring system of FIG. 1A.

FIG. 8 is a right side perspective view of a second embodiment of an automated weight scale nutrient and caloric monitoring system.

FIG. 9 is an exploded perspective view of the automated weight scale nutrient and caloric monitoring system of FIG. 8.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The automated weight scale nutrient and caloric monitoring system (hereafter the “automated scale system”) will now be described with occasional reference to specific embodiments. The automated scale system may, however, be embodied in different forms and should not be construed as limited to the embodiments set forth herein. Rather, these embodiments are provided so that this disclosure will be thorough and complete, and will fully convey the scope of the automated scale system to those skilled in the art.

The description and figures disclose an automated scale system. Generally, the automated scale system includes a smart base configured to measure the weight of consumable items and further configured to transmit the weight data to an integrated computer processor, in real-time. The real time transmission of the weight data eliminates the need for manual input by a user, thereby providing an easier, more efficient, and non-labor intensive means for obtaining and tracking nutrient and calorie data of the consumable items.

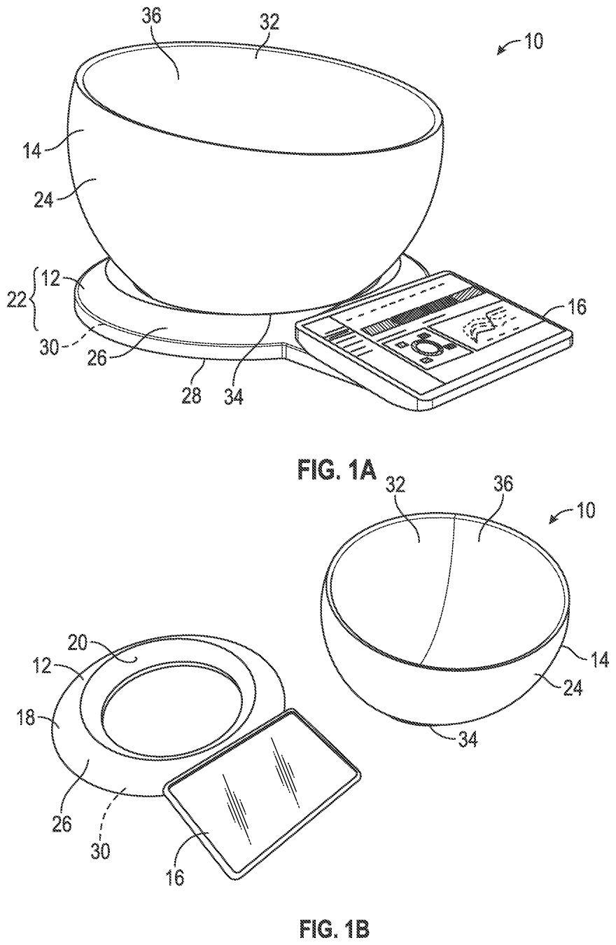

Referring now to FIGS. 1A and 1B, the automated scale system is illustrated generally at 10. The automated scale system 10 includes a smart base 12 configured to support a vessel 14 (such as a bowl, as a non-limiting example) and an interface display 16.

Referring again to FIGS. 1A and 1B, the smart base 12 has an enclosure in the form of an annular ring 18 that includes an inner wall 20, also referred to as an “inner core.” The inner wall 20 of the annular ring 18 is configured to receive a portion of the vessel 14 in a manner such as to support the vessel 14 during use of the automated scale system 10. In the illustrated embodiment, the inner wall 20 has a concave profile configured to approximate a profile of a lower portion 22 of an outer wall 24 of the vessel 14. However, it is contemplated that in other embodiments, the inner wall 20 can have other profiles sufficient to receive a portion of the vessel 14 in a manner such as to support the vessel 14 during use of the automated scale system 10.

Referring again to FIGS. 1A and 1B, the smart base 12 includes an outer wall 26 and a bottom wall 28 configured to extend from the inner wall 20 to the outer wall 26. The walls 20, 26 and 28 cooperate to form a cavity 30 within the smart base 12. As will be discussed in more detail below, the cavity 30 is configured to house electronic components (not shown for purposes of clarity).

Referring again to FIGS. 1A and 1B, the bowl 14 has the outer wall 24 and an inner wall 32. The walls 24 and 32 extend to a vessel bottom 34. The outer wall 24 and the vessel bottom 34 cooperate to define a cross-sectional profile that approximates the inner wall 20 of the smart base 12 in a manner such that the vessel 14 seats within the smart base 12 and is supported by the smart base during use of the automated scale system 10. In the embodiment illustrated in FIGS. 1A and 1B, the vessel 14 has the form of a common bowl, as can be typically found in a kitchen. However, in other embodiments, the vessel 14 can have other forms sufficient for the functions described herein.

Referring again to FIGS. 1A and 1B, the inner wall 32 of the vessel 14 defines a vessel cavity 36. The vessel cavity 36 has a concave cross-sectional profile and is configured to receive consumable items (not shown) for weighing purposes. While the embodiment of the vessel cavity 36 shown in FIG. 1A has a concave cross-sectional profile, in other embodiments, the vessel cavity 36 can have other cross-sectional profiles sufficient to receive consumable items (not shown) for weighing purposes.

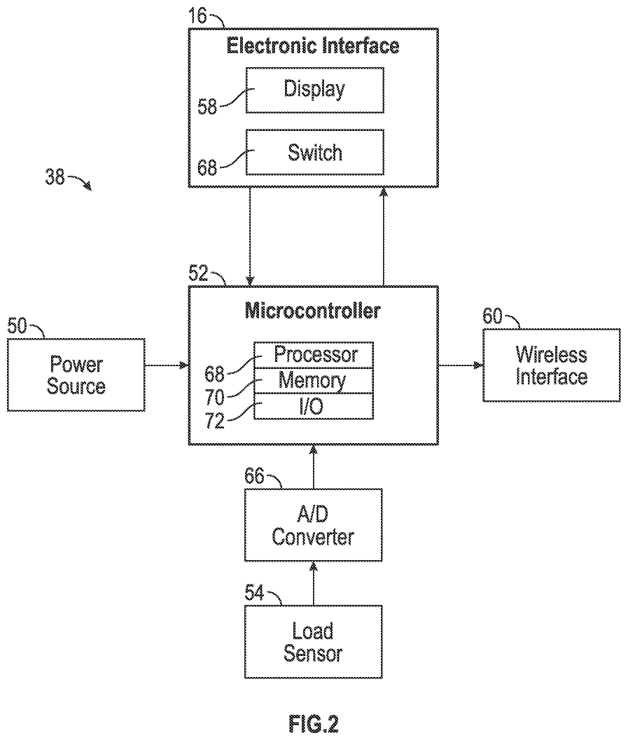

Referring now to FIGS. 1A, 1B and 2, the cavity 30 formed within the smart base 12 is configured to house electronic components 38. The housed electronic components 38 include a power source 50, a microcontroller 52, one or more load sensors 54, the interface display 16, a wireless communications interface 60 and an analog to digital converter 66.

Referring now to FIG. 2, the microcontroller 52 includes a processor 68 such as a microprocessor, a memory 70, and input/output (I/O) device 72. The processor 68 is configured for communication with the wireless communication interface 60 and is capable of processing, receiving, and transmitting data or instructions. The processor is further configured to access the memory 70 having a tangible, non-transitory storage medium on which processor-executable instructions are embodied. The processor-executable instructions include at least one program to be executed by the processor 68, such as for example, instructions to perform at least one operation or function with respect to the smart base 12.

Referring again to FIG. 2, the power source 50 is configured to provide power to the electronic components 38. In the embodiment shown in FIG. 2, the power source 50 has the form of a rechargeable battery, such as the non-limiting example of a lithium polymer battery. It should be appreciated that in other embodiments, a skilled artisan may select other suitable power sources while still remaining within the scope of the disclosure. Non-limiting examples of alternate power sources can include a power source 50 that is internal or external to the smart base 12, such as a battery, an energy-storing microchip, solar energy, and/or an electrical cord plugged into a standard wall socket. It should also be appreciated that in other embodiments, a skilled artisan may scale the power source 50 as desired.

Referring again to FIG. 2, the one or more load sensors 54 can be disposed at various locations on the smart base 12, including the non-limiting example of adjacent to the inner wall 20 such that the one or more load sensors 54 are positioned between the vessel 14 and the smart base 12. The one or more load sensors 54 can be one or more load cells, as a non-limiting example. As another non-limiting example, the one or more load sensors 54 can be positioned adjacent the bottom wall 28 such that the one or more load sensors 54 are positioned between the smart base 12 and a support surface (not shown), such as for example a countertop or tabletop.

Referring now to FIGS. 1A, 1B and 2, the interface display 16 is connected to and extends from a portion of the smart base 12. The interface display 16 includes a display 58 configured to visually present information to the user and/or offer user input options authorizing the user to interact with the automated scale system 10. As one non-limiting example, the display 58 can prompt the user to select a standard unit of measurement (e.g., pounds, grams, ounces, etc.) in which to weigh the item being measured.

Referring again to FIGS. 1A, 1B and 2, the display 58 can have any form, such as the non-limiting examples of a liquid crystal display (LCD) or light emitting diode (LED) display. It is also contemplated that the display 58 can have the form of a touchscreen configured to permit the user to enter a touch input using infrared technology or capacitive technology.

Referring again to FIGS. 1A, 1B and 2, the interface display 16 includes one or more switches 68 configured to facilitate the user to enter input. In the illustrated embodiment, the one or more switches 68 have the form of touch buttons. However, in other embodiments, the one or more switches 68 can have other forms, such as the non-limiting example of digital toggle switches. It should be understood that the interface display 16 can be configured to include both a touchscreen and physical switches permitting the user to choose a desired user input method.

Referring again to FIGS. 1A, 1B and 2, the load sensors 54 are connected to an analog-to-digital converter (A/D converter) 66, which is configured to receive analog signals from the load sensors 54, and covert the analog signals into digital signals for delivery to the processor 68 of the microcontroller 52. The processor 68 is configured to generate an output signal indicative of the measured weight supplied by the load sensors 54, which is received by the display screen 58 to display the nutritional data.

Referring again to FIGS. 1A, 1B and 2, the wireless communication interface 60 is adapted to provide communication between the processor 68 of the microcontroller 52, by way of a transmitter, receiver, and/or transceiver (not shown for purposes of clarity), and an electronic device. As one non-limiting example, the microcontroller 52 is configured for communication with and/or have included with it a transceiver such as a Bluetooth radio transceiver for communication to the electronic device. In a specific example, the microcontroller 52 is configured for communication with an electronic device using Bluetooth Low Energy Protocol (BLE). It should be appreciated that one skilled in the art may use other wireless communication protocols, such as for example, ANT, Zigbee, LoRa and/or LoRaWAN, while remaining within the scope of the present disclosure.

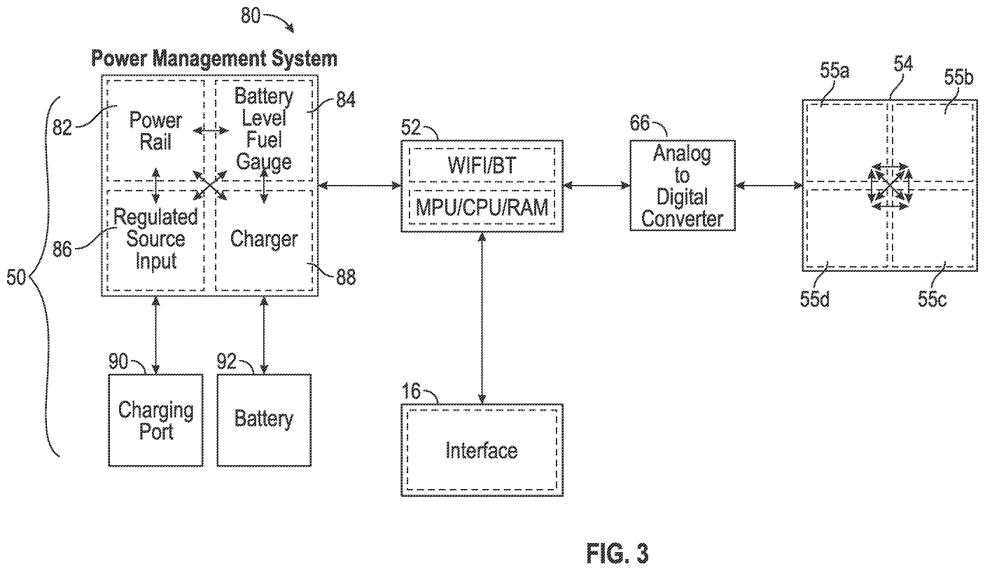

Referring now to FIG. 3, a more detailed block diagram of portions of the housed electronic components 38 is illustrated. The power source 50 includes a power management system 80 having a power rail 82, a battery level fuel gauge 84, a regulated source input 86 and a single cell lion charger 88. The power rail 82, a battery level fuel gauge 84, a regulated source input 86 and a single cell lion charger 88 are electrically coupled to each other and are configured to manage the power consumption of the automated scale system 10 and further configured to distribute the power amongst the various electronic components 38. In the illustrated embodiment, the charger 88 has the form of a lithium ion style of charger. In other embodiments, the charger 88 can have other forms, sufficient for the functions described herein. In certain embodiments, a charging port 90 is electrically coupled to the regulated power source 86 and is configured to provide electrical access to the power management system 80 for charging purposes. In the illustrated embodiment, the charging port 90 has the form of a USB style of port. However, in other embodiments, the charging port 90 can have other forms sufficient to provide electrical access to the power management system 80 for charging purposes. In certain embodiments, a battery 92 is electrically coupled to the charger 88 and is configured to provide electrical current to the charger 88. In the illustrated embodiment, the battery 92 has the form of a 3.7 volt lithium polymer battery. However, in other embodiments, the battery 92 can have other desired forms sufficient to provide electrical current to the charger 88.

Referring again to the embodiment illustrated in FIG. 3, the one or more load sensors 54 have the form of a quantity of four (4) load sensors 55a-55d arranged in two rows of two and in electrical communication with each other. However, in other embodiments, the load sensors 55a-55d can be arranged in other patterns, such as the non-limiting examples of concentrically arranged around a common center or arranged in a square or rectangle shaped pattern. It should be understood that a skilled artisan may use more or less than a quantity of four (4) load sensors and position the location of the load sensors 55a-55d as desired.

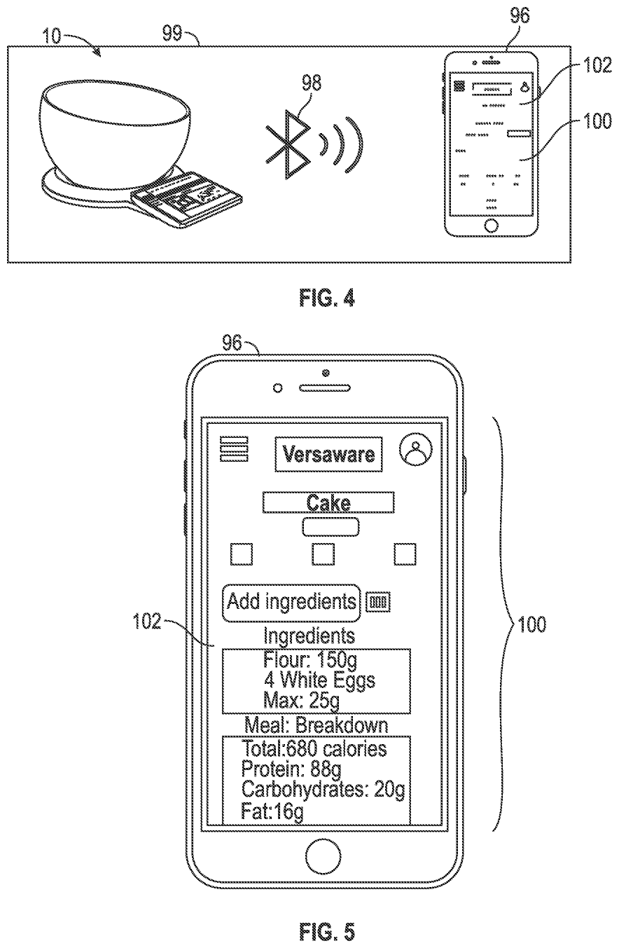

Referring now to FIGS. 4 and 5, the automated scale system 10 is configured to connect to an electronic device 96 via wireless communication 98 and transmit nutritional data to the electronic device 96, in real-time. In the illustrated embodiment shown in FIGS. 4 and 5, the electronic device 96 has the form of a smartphone. It should be appreciated that the electronic device 96 is not limited to a smartphone and that one skilled in the art may utilize other electronic devices, such as a laptop computer, desktop computer, handheld or tablet computers, smart watches, portable media players and the like having wireless communication capabilities, as desired. The combination of the automated scale system 10 and an electronic device 96 advantageously forms a health tracking system.

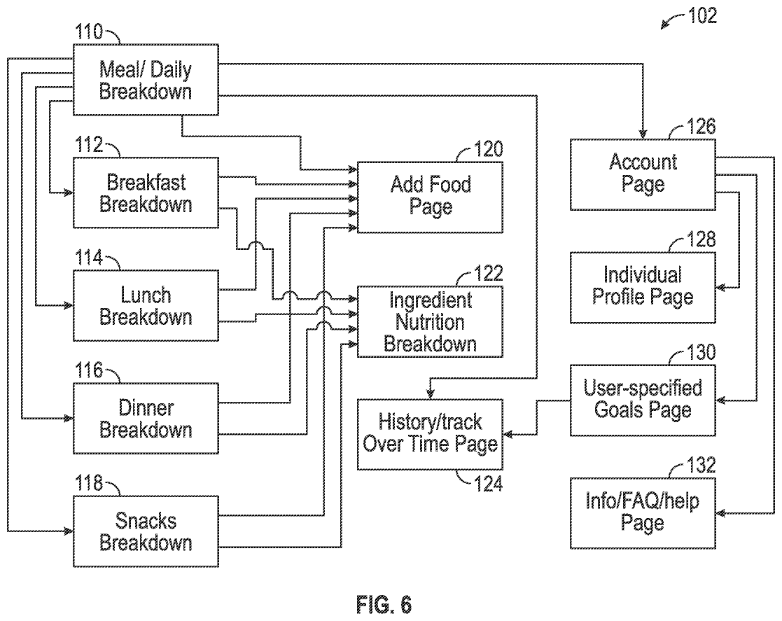

Referring again to FIGS. 4 and 5, the electronic device 96 has an electronic device display 100. The electronic display device 100 is configured to present a graphical user interface 102 (GUI) for enabling a user to obtain and track macronutrients and calorie data of consumable items using the electronic device 96. One non-limiting example of a graphical user interface 102 is shown in FIG. 6. The graphical user interface 102 includes a first screen 110 indicating a meal/daily breakdown, a second screen 112 prompting a breakfast breakdown, a third screen 114 showing a lunch breakdown, a fourth screen 116 illustrating a dinner breakdown, a fifth screen 118 prompting a snacks breakdown, a sixth screen 120 indicating to add a food page, a seventh screen 122 showing an ingredient nutrition breakdown, an eighth screen 124 indicating a history/tracking over time, a ninth screen 126 illustrating an account page, a tenth page 128 showing an individual profile page, an eleventh page 130 prompting a user specified goals page and a twelfth page 132 showing information/frequently asked questions and help. In certain embodiments, the various screens 110, 112, 114, 116, 118, 120, 122, 124, 126, 128, 130 and 132 of the of the graphical user interface 102 can be in communication with each other as schematically depicted in FIG. 6. However, it should be appreciated that in other embodiments, the graphical user interface 102 can include more or less screens and the screens can be in communication with each other as desired.

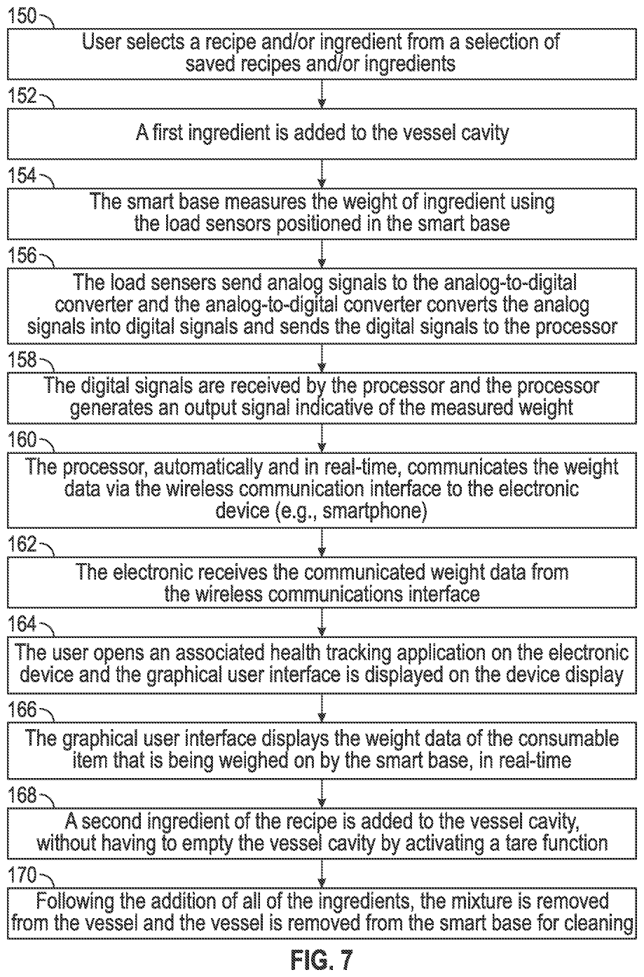

Referring now to FIG. 7, operation of the automated scale system 10 will now be described. In an initial step 150 and with the vessel 14 detachably seated on the smart base 12, a user selects a recipe and/or ingredient from a selection of saved recipes and/or ingredients. In a next step 152, a first ingredient, such as the non-limiting example of flour, is added to the vessel cavity 36. Next, in step 154, the smart base 12 measures the weight of the ingredient using the load sensors 55a-55d positioned in the smart base 12. In next step 156, the load sensors 55a-55d send analog signals to the analog-to-digital converter 66. The analog-to-digital converter 66 converts the analog signals into digital signals and sends the digital signals to the processor 68. Next, in step 158, the digital signals are received by the processor 68 and the processor 68 generates an output signal indicative of the measured weight. In next step 160, automatically and in real-time, the processor 68 communicates the weight data via the wireless communication interface 60 to the electronic device 96 (e.g., smartphone).

Referring again to FIGS. 5 and 7, the electronic device 24 (e.g., smartphone) includes a processor (not shown for purposes of clarity). In a next method step 162, the electronic device processor is configured to receive the communicated weight data from the wireless communications interface 60. Next, in step 164, the user opens an associated health tracking application on the electronic device 96 and the graphical user interface 102 is displayed on the device display 100. In a next step 166, the graphical user interface 102 displays the weight data of the consumable item that is being weighed on by the smart base 12, in real-time. Advantageously, the automated scale system 10 provides that as the user is adding the ingredient to the vessel seated on the smart base 12, the weight data is continuously updated to the electronic device 96, thereby guiding the user to put a desired amount of the ingredient, as required by a recipe, into the vessel cavity 36. As one non-limiting example, if a recipe calls for 120 grams of an ingredient such as flour, the user can begin adding flour to the vessel cavity 36 and reference the real-time weight measurement the graphical user interface 102 displayed by the electronic device until the weight reaches 120 grams. Similarly, if the user adds more than 120 grams, the user can remove the necessary flour while referencing the real-time weight measurements until the weight is 120 grams.

Referring again to FIG. 7 in a next step 168, a second ingredient (e.g., eggs) of the recipe is added to the vessel cavity 36, without having to empty the vessel cavity 36. Instead of having to remove the first ingredient from the vessel cavity 36, the smart base 12 can include a tare function via a tare button on the display 58 or through the graphical user interface 102 of the application contained on the electronic device 96. When the user activates the tare function, the weight of the smart base 12, the vessel 14, and any ingredient(s) already in the vessel cavity 36 are eliminated thereby setting the current weight to zero. The tare function allows the user to follow multi-ingredient recipes and permits the user to measure the weight of each ingredient individually as the ingredient is being added.

Referring now to FIG. 5, advantageously the graphical user interface 102 is configured to display an aggregate meal page listing all the ingredients in the recipe, along with the macronutrients and calorie data for each ingredient.

Referring now to FIG. 7 in a final method step 170, following the addition of all of the ingredients, the mixture is removed from the vessel 14 and the vessel 14 is removed from the smart base 12 for cleaning purposes.

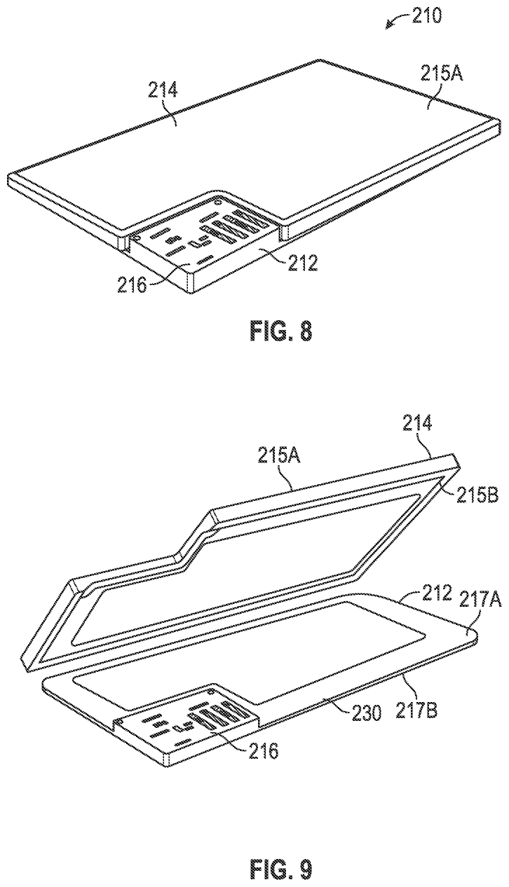

While the embodiment of the automated scale system 10 shown in FIGS. 1A, 1B and 4 has the form of a smart base 12 supporting a vessel 14 with the vessel 14 having the form of a bowl, as will discussed in more detail below, the automated scale system 10 can have other forms. Referring now to FIGS. 8 and 9, in another embodiment, an automated scale system is shown generally at 210. The automated scale system 210 has the form of a cutting board 214 removably coupled to a smart base 212.

Referring again to FIGS. 8 and 9, the cutting board 214 has an upper major surface 215A and an opposing lower major surface 215B. In a manner similar to conventional cutting boards, the upper major surface 215A is configured for food preparation, including the known functions of cutting, slicing, dicing and the like. The lower major surface 215B is configured to seat on an upper surface 217A of the smart base 212. The cutting board 214 can be formed from known materials, such as the non-limiting examples of wood, cork, polymeric materials and the like.

Referring again to FIGS. 8 and 9, the smart base 212 includes the upper surface 217A, an opposing lower surface 217B and an integrated interface 216. The upper surface 217A and the lower surface 217B are spaced apart a distance such that a smart base cavity 230 is formed therewithin. The smart base cavity 230 formed within the smart base 212 is configured to house electronic components (not shown for purposes of clarity). The housed electronic components include a power source, a microcontroller, one or more load sensors, the interface, a wireless communications interface and an analog to digital converter. In the illustrated embodiment, the electronic components housed within the smart base cavity 230 are the same as, or similar to, the electronic components 38 described above and shown in FIGS. 2 and 3. However, it should be appreciated that in other embodiments, the electronic components housed within the smart base cavity 230 can be different from the electronic components 38 described above and shown in FIGS. 2 and 3.

Referring again to the embodiment shown in FIGS. 8 and 9, the integrated interface 216 is the same as, or similar to, the interface display 16 described above and shown in FIGS. 1A, 1B and 4. However, it should be appreciated that in other embodiments, the integrated interface 216 can be different from the interface display 16 described above and shown in FIGS. 1A, 1B and 4.

Referring again to FIGS. 8 and 9, in operation and in a manner similar to the vessel 14 described above and shown in FIGS. 1A and 1B, the upper surface 215A of the cutting board 214 is configured to receive consumable items (not shown) for weighing purposes. The weight of the consumable items is determined by the one or more load sensors positioned in the smart base 212. Further to the operation in a manner similar to the automated scale system 10 described above, the integrated interface 216 is configured to visually present information to the user and/or offer user input options authorizing the user to interact with the automated scale system 210.

While the embodiment of the smart base 212 and the cutting board 214 shown in FIGS. 8 and 9 each have a generally rectangular shape, in other embodiments the smart base 212 and the cutting board 214 can have other shapes sufficient for the functions described herein.

Referring again to FIGS. 8 and 9, in operation the automated scale system 210 is configured to connect to an electronic device (not shown) via wireless communication and transmit nutritional data to the electronic device, in real-time.

Referring now to FIGS. 1A, 1B, 8 and 9, the automated scale systems 10, 210 provide an easier, efficient, and non-labor intensive means for obtaining and tracking macronutrients and calorie data of consumable items by providing real-time measurements. Each of the automated scale systems 10, 210 use an external electronic device, such as a smartphone, to receive and process measurement data, to process that measurement data in conjunction with data stored on the electronic device, and/or data and/or instructions downloaded to the electronic device from the Internet.

It should be appreciated that the automated scale systems 10, 210 can include other features, components and devices and can be used in a variety of beneficial manners. Various embodiments are presented below.

In other embodiments, it is contemplated that the smart bases 12, 212 can include a camera or other optical detection device, a microphone, and/or a user interface such as a touchscreen interface. In this embodiment, rather than sending the weight information to a separate electronic device, the smart base may ascertain the calories and/or other nutritional attributes of that ingredient without resort to data processing on electronic device. In one scenario, the user may employ the user interface to manually type the ingredient being weighed, such as by inputting data via a touchscreen, i.e. typing. The user may type the entire name, or may type the first few letters to narrow a broad list of stored ingredient names.

In some embodiments, the user may select from a list of ingredients stored in memory, e.g. by using a dropdown box displayed on the user interface. In other embodiments, a microphone integrated into the smart base 12, 212 may detect and transform oral speech from the user into electrical signals, which are then preferably converted to digital signals then ultimately to words using voice recognition technology well known to those skilled in the art, e.g. “apple,” “whole wheat flour,” etc. The voice recognition processing and result may occur within the smart base 12, 212, or the sounds may be processed remotely at a server in the Cloud and the resulting word downloaded to the smart base 12, 212. In some embodiments, nutritional values associated with the ingredient may be stored on the Internet and transmitted as required to the smart base 12, 212. In other embodiments, the nutritional data may reside in a database stored on the smart base 12, 212. In some embodiments, the smart base 12, 212 may use a combination of stored data and data retrieved from an external database accessible through the Internet.

In another embodiment, the smart base 12, 212 may comprise an optical reading device such as a camera. In such embodiments, the optical reading device may “scan” a UPC bar code or equivalent (e.g., a QR code) associated with the ingredient being weighed, e.g. a certain brand of canned tomato paste. As described above in connection with embodiments employing an electronic device, the smart base 12, 212 used the calories and/or other nutritional data associated with the ingredient and calculates gross calories and nutrition values of the amount of that ingredient being weighed by accessing the nutrition data associated with that ingredient.

In still other embodiments, the nutritional values associated with any given ingredient may be accessed by the processor 68 from local memory 70 residing within the smart base 12, 212, or in communication with the smart base 12, 212, such as the non-limiting examples of via an external memory source (e.g. a memory stick), or via the Internet to access an external database residing in the cloud. Regardless of where the nutritional data is stored for a given ingredient, in this embodiment an integrated processor 68 performs the necessary calculations to display to the user the nutritional data of the ingredient(s). Using the aforementioned user interface, a user may select one or more classes of nutrition data to be displayed or communicated to the user, e.g. calories, protein, carbohydrates, zinc, etc.

In certain embodiments, it is contemplated that the smart bases 12, 212 may be in communication with one or more databases and/or processors that reside external to the smart bases 12, 212, such as the non-limiting example of in the Cloud.

In certain embodiments, it is also contemplated that the smart bases 12, 212 will be used in conjunction with a mobile application recommending or storing recipes, diets, and other health information. The app may function as downloadable software processed on a local processor or be cloud-based. For example, a power lifter may access an app for advanced muscle building. After receiving the weight and nutritional attributes of the user's measured ingredients, the app may recommend modifications for better and/or more targeted results, e.g. “Add an egg to boost protein by 6 grams.” The associated app may communicate with the smart bases 12, 212 to allow for: comprehensive and modular recipe building, a customizable diet platform for health or fitness, and/or streamlined nutritional understanding for the user and trainer. Additionally, the method and systems described herein may support sponsored and/or targeted advertising to users.

In certain embodiments, it is further contemplated that the smart bases 12, 212 may form part of a “data driven diet system” featuring improved data flow and processing for users. Such a system may be comprised of one or more 1) smart bases having one or more features as described above, 2) software residing in whole or in part in the cloud, 3) databases residing in whole or in part in the cloud, and 4) devices in communication with the internet.

In certain embodiments, it is contemplated that a user may create and modify a profile of user information. The user profile may comprise user-entered data and/or data passively collected by the smart bases 12, 212 in the course of operations relating to the timing, types and amounts of ingredients utilized by a user. Such data may be useful to third party practitioners. For example, in some embodiments a user may connect his/her individual nutrition profile created (such as upon installation of a downloaded application) for transmission to certified third party practitioners. Such transmission may be specially initiated by the user or in other embodiments may be passive depending on user permissions. These practitioners include, but are not limited to, doctors, physical therapists, nutritionists, dieticians, personal trainers and the like. In some embodiments, a practitioner may connect to a user's account to establish, monitor, and track the user's food consumption nutrient levels in accordance with the goals or requirements imposed on them by their connected practitioners. In some embodiments, users may be able to link their practitioners to their accounts based on a mutual third-party agreement set in place, and agreed to, by both parties. A practitioner may be empowered to set macro and micronutrient targets, as well as caloric targets, for a specific meal or for any period of time depending on the agreed upon level of involvement the client wishes their practitioner to be involved. In some embodiments, data from the smart bases 12, 212 may be transmitted to practitioners, for example through a mobile app to the cloud, for the practitioner to either view on a desktop application or a mobile application.

In some embodiments the smart bases 12, 212 may connect with other appliances controlled by the user, or controlled by a third party. Depending on the configuration—e.g. whether the smart base 12, 212 is connected to a separate device (such as a smart phone) via hard cable or Bluetooth, or comprises an integrated CPU independently connected to the internet, or any other combination of device and internet connectivity known to those in the art—a mobile application may enable a user to connect to other devices such as Bluetooth devices including fitness watches and smart body scales, so that the mobile application can grasp a sense of user weights and caloric burn. Other vitals such as average heart rate, BMI, cholesterol, and more may be communicated to the mobile application and/or a database residing in the cloud via the internet, and saved into a user's profile based on the data collected from the specific peripheral Bluetooth device. Such devices could include glucose monitors for diabetics. In some embodiments it may be preferable to transmit such data to the cloud and for storage on each user's individual cloud server.

In certain other embodiments, the smart bases 12, 212 could cooperate with a mobile application, such as software offered as a service or software downloaded to the smart bases 12, 212 or a separate device in communication with the smart bases 12, 212, to establish and monitor pre-set consumption profiles based on human demographics. For example, the smart bases 12, 212, in cooperation with a mobile application, might allow a user to import pre-set nutrient profiles for the meal they are about to make based on selectable demographical profile diet recommendations. These demographical profiles include a variety of health and fitness profiles including but not limited to pregnancy, diabetics, vegans, vegetarians, gluten-free, osteoporosis, post-surgery, blood-loss, anemia, athletic requirements, or any categorical user profile with specific nutrition needs. In some embodiments, a user might import these profiles from the cloud by selecting the option to build pre-set meals. These profiles might be continuously updated via lambda functions that might be updated through artificial intelligence (e.g. as the mobile app “learns” a user's diet and activity patterns) or modified by the user or others, means such as by third party software. Such updates would enable the user to have access to continually evolving dietary needs based on personal medical reasons.

In still other embodiments, a user may utilize pre-set consumption profiles based on food taste and type. As noted above, in some embodiments the smart bases 12, 212 are in communication with the Internet, either through integrated communication capabilities or through a separate appliance, connected to the internet and to the electronic device, such as a smart phone. Using the smart bases 12, 212 or a connected appliance, a user may import pre-set nutrient profiles for the meal he/she is about to prepare based on the individuals food taste preferences or types. These food profiles include, but are not limited to, deserts, lunch, dinner, savory, sweet, umami, sour, etc. In some embodiments, a user might import these profiles from the cloud by selecting the option to build pre-set meals based on desired food taste or type from the on-board screen located on the physical measuring device itself. This functionality can also be achieved on the individual's mobile application as well, where the smart bases 12, 212 can then access the information by grabbing the data from the cloud where the meal data on the mobile application was stored. These profiles may be updated via artificial intelligence and/or through lambda functions and/or updated, for example, by third party practitioners or software developers. Such updates may enable the user to have access to continually evolving dietary needs based on personal food preferences on taste and type.

In other embodiments, a user may pre-set consumption profiles based on human feeling, behavior, psychology, or mood. The smart bases 12, 212, in conjunction with a computer processor and software (preferably cloud-based and accessible through a mobile app), allows a user to import pre-set nutrient profiles for the meals they are about to make based on the specific mood, feeling, behavior, or psychological effect the user would like to have for the day. Users can import profiles for these feelings for the meals they are about to make that include, but are not limited to, sustained energy, happiness, relaxation, enthusiasm, positivity, engagement, satisfaction, sleepiness, awareness, and more. The science behind diet and these behaviors is scientifically backed, and the associated nutrients attributable to these behaviors can be automatically set into the user's meal dashboard upon selection of any of these behaviors for the meal that they are about to make. These profiles may be continuously updated as described above. Such updates enable the user to have access to continually evolving dietary needs based on desired personal moods and behaviors.

In certain other embodiments, a user may exploit artificial intelligence to advance dietary and related goals. For example a user might subscribe to a software application which generates suggested recipes suggested in whole or in part on ingredients indicated as likely available to the user and artificial intelligence. Such a platform might enable a user to utilize the ingredients that they have available to them along with the nutrient requirements that they would like their meal to be comprised of. In other embodiments; the data driven diet system, comprising the above described smart bases 12, 212, may use machine learning to build custom meal recipes that meet the specified nutrient requirements the user has requested. The results might display a list of a one or more recipes that meet the criteria based on a database, both internal and external, that the user can select from. These recipes can be altered once a selected meal has been imported into the user's dashboard. This functionality could be enabled on the mobile application side and/or the embedded electronic components. These recipes could inform the user what quantities of what ingredients are needed to make the meal that the system is walking the user through. The device and/or other component of the system may notify the user what ingredients to weigh and when to stop weighing the ingredients. A system comprising an artificial intelligence component might enable the user to set the nutrient goals they would like to consume for any given period and the meal types (based on demographic, taste, mood, behavior and the like). Further, a system comprising an artificial intelligence component could generate a personalized shopping list for the user to take to the grocery store. It is also contemplated that a data driven diet system could also be used with third-party grocery or restaurant delivery applications, such as Kroger®, InstaCart®, and GrubHub®, wherein a user may request for these applications to assemble and/or deliver groceries or take-out restaurant meals.

In yet another embodiment, the data driven diet system could include a social media aspect, such as capability of sharing recipes or other facts or opinions on a Sharing Platform. A user might follow their closest friends, family, personal trainers, or anyone that utilizes the data driven diet system to see what meals their followings are making. In some embodiments, users can import meal recipes from their social network. In some embodiments, shared recipes will automatically populate all the relevant information for the user onto the dashboard for the meal, and much like the Recipe artificial intelligence described above, will walk the user through the steps needed to make the same recipe. These imported recipes can also be saved for a specific meal the user plants to eat in the future. The user can alter the uploaded nutrient profiles downloaded onto a user dashboard, located on the interface, to personally adjust any of the meal's information to allow for more flexibility. This allows the user more modularity to custom tailor-make any meal to meet personal or prescribed needs.

In some embodiments, a data driven diet system may be updated at any time via firmware updates, either via software residing in the Cloud or software residing on the smart base 12, 212, for example, via Over-The-Air firmware updates that can be downloaded from the cloud. In some embodiments, users may have the option to continuously update the latest firmware for the devices they use to stay most up to date with the lates profiles, recipe features, product functional architecture, and more. In some other embodiments, two or more measuring devices may be employed as part of a data driven diet system. Firmware updates will be automatically notified to the user and can be scheduled to be downloaded at any time most convenient to the users. In yet other embodiments, a user might use two or more smart bases 12, 212 in the system (e.g. a vessel-based system and a cutting board based system, both as described above) to prepare a single meal. In such case, the smart bases of each system may communicate with each other and/or with some or all other components of the data driven diet system, to measure, record, process, and communicate the combined dietary information as discussed, so that the user can build towards the nutrient goals for that one meal but with multiple appliances.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A smart base for use with an automated weight scale nutrient and caloric monitoring system, the smart base comprising:
an enclosure;
one or more load sensors positioned proximate the enclosure and configured to weigh consumable items;
a microprocessor positioned proximate the enclosure and having a processor, an analog-to-digital converter and an input/output interface;
a wireless interface positioned proximate the enclosure;
a display interface positioned approximate the enclosure; and
a power source positioned approximate the enclosure and configured to power the one or more load sensors, the microprocessor, the wireless interface and the display interface;
wherein the one or more load sensors are configured to measure weight data of consumable items, and wherein the microprocessor is configured to generate an output signal indicative of the weight data measured, and wherein the wireless interface is configured to transmit the weight data measured to an electronic device in real-time while the consumable item is being weighed by the one or more load sensors.

2. The smart base of claim 1, wherein the enclosure has a form of an annular ring having a hollow inner core and configured to support a vessel containing the consumable items.

3. The smart base of claim 2, wherein the vessel is a convention kitchen bowl.

4. The smart base of claim 1, wherein the one or more load sensors are arranged in two rows of two and are in electrical communication with each other.

5. The smart base of claim 1, wherein the weight data measured transmitted to the electronic device is accessed by an application contained within the electronic device.

6. The smart base of claim 1, wherein the power source includes a power management system having a power rail.

7. The smart base of claim 1, wherein the smart base is configured to measure the weight data of a second ingredient in a vessel without removing a first ingredient from the vessel.

8. An automated weight scale nutrient and caloric monitoring system comprising:
a smart base having electronic components and one or more load sensors;
a kitchen device configured to seat on the smart base and further configured to receive consumable items; and
an electronic device in communication with the smart base;
wherein the one or more load sensors are configured to measure weight data of the consumable items placed in a vessel, and wherein the electronic components are configured to generate an output signal indicative of the weight data measured, and wherein the electronic components are further configured to transmit the weight data measured to an electronic device in real-time while one of the consumable items is being weighed by the smart base.

9. The automated weight scale nutrient and caloric monitoring system of claim 8, wherein the electronic device is a smart phone.

10. The automated weight scale nutrient and caloric monitoring system of claim 8, wherein the smart base has a rectangular shape.

11. The automated weight scale nutrient and caloric monitoring system of claim 8, wherein the electronic components are positioned within a cavity formed within the smart base.

12. The automated weight scale nutrient and caloric monitoring system of claim 8, wherein the kitchen device is a cutting board.

13. The automated weight scale nutrient and caloric monitoring system of claim 8, wherein the smart base is configured to measure the weight data of a second ingredient positioned on the kitchen device without removing a first ingredient from the kitchen device.

14. A method of operating an automated weight scale nutrient and caloric monitoring system, the method comprising steps of:
selecting a recipe and/or ingredient from a selection of saved recipes and/or ingredients;
adding a first ingredient to a vessel cavity;
weighing the weight of the first ingredient using one or more load sensors;
generating and sending analog signals representing the weight of the first ingredient to an analog-to-digital converter;
converting the analog-to-digital signals to digital signals;
communicating the digital signals in real time to an electronic device;
displaying the communicated digital signals on a health tracking application accessed by the electronic device;
adding a second ingredient to the vessel cavity without removing the first ingredient;
weighing the weight of the second ingredient using one or more load sensors; and
displaying an aggregate meal page listing all the ingredients, along with macronutrients and calorie data for each ingredient.

15. The method of claim 14, including a step of arranging the one or more load sensors in two rows of two.

16. The method of claim 14, including a step of positioning a display interface proximate the one or more load sensors.

17. The method of claim 16, including a step of equipping the display interface with a touchscreen configured to permit a user to enter a touch input or a button separate from the display interface.

18. The method of claim 17, including a step of equipping the display interface with a switch configured to permit a user to interact with a measuring device.

19. The method of claim 14, including a step of accessing a cloud-based diet and health software application via an internet connection.

20. The method of claim 14, including a step of reading first or second ingredient information with an optical reading device.
